(19) United States
(12) Patent Application Publication
(10) Pub. No.: US 2002/0078429 A1
(43) Pub. Date: Jun. 20, 2002

(54) Design method for control system, control system, adjustment method for control system, exposure method, and exposure apparatus

(75) Inventor: Kouji Yoshida, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Tokyo (JP)

(21) Appl. No.: 09/994,827

(22) Filed: Nov. 28, 2001

(30) Foreign Application Priority Data
Nov. 29, 2000 (JP) 2000-362694

(51) Int. Cl. G06F 17/50

(52) U.S. Cl. 716/21

(57) ABSTRACT

In a control system, by employing optimization such as a genetic algorithm that globally searches for an optimal solution and, for evaluating given capability of the control system, uses such an evaluation function that its having unimodal when each of at least one continuously variable parameter of the control system varies is not guaranteed or a plurality of evaluation functions that vary independently of each other when each of at least one continuously variable parameter varies, an optimal solution of the at least one continuously variable parameter is obtained. Therefore, the control system optimized in terms of the given capability can be implemented.

### BACKGROUND OF THE INVENTION

1. Field of The Invention

The present invention relates to a design method for a control system, a control system, an adjustment method for a control system, an exposure method, and an exposure apparatus, and more specifically to a design method with which to design a control system that controls an object to be controlled, a control system designed using the design method for a control system, an adjustment method with which to adjust a control system that controls an object to be controlled, an exposure method that uses the control system or the adjustment method for a control system, and an exposure apparatus comprising the control system.

2. Description of The Related Art

In a lithography process for manufacturing semiconductor devices, liquid crystal display devices or the like, an exposure apparatus has been used which transfers a fine pattern formed on a mask or reticle (both referred to as a “mask” or “reticle” as needed, hereinafter) through a projection optical system onto a substrate such as a wafer or a glass plate (referred to as a “sensitive substrate” or “wafer” hereinafter), which is coated with a resist. Although as such exposure apparatuses, reduced-projection-type exposure apparatuses (so-called steppers) of a step-and-repeat method have been mainly used, scan-type exposure apparatuses of a step-and-scan method (scanning-steppers), which can perform highly accurate exposure of larger areas, are getting widely used as the sizes of pattern features shrink due to semiconductor devices becoming highly integrated.

In any type of exposure apparatus, a wafer needs to be highly accurately positioned in the exposure position in terms of highly accurate exposure, and the wafer needs to be moved at high speed in terms of throughput. Therefore, a control system is provided which controls the movement of a movable, wafer stage on which the wafer is mounted in order to control the movement of the wafer. And in the controlling of the movement of the wafer, the control system usually performs feedback control of both position and speed of the stage based on measurement results of the position and speed thereof and a target track from an initial position (current position) to a target position.

As described above, in designing such a control system for feedback control of both position and speed of the stage, loop gains of the position-feedback loop and speed-feedback loop (hereinafter, referred to as a “position-loop gain” and a “speed-loop gain” respectively) are determined as parameters. Needless to say, the design parameters are preferably optimized such that the capability of the stage such as the accuracy of positioning in the target position and the time required to move to the target position (including convergence time) is improved. However, the position-loop gain and speed-loop gain affect the capability of the stage not independently.

That is, the capability of the stage does not vary monotonously when the position-loop gain and speed-loop gain vary. Therefore, in the prior art, local optimum solutions are obtained within a range of the design parameters' values obtained from experience, using a linear-programming or hill-climbing method.

As described above, it often occurs that given capability of a control system does not vary monotonously when the design parameters of the control system vary, regardless of the number of the parameters. In such a case, local optimum solutions are obtained using the linear-programming or hill-climbing method, likewise.

That is, it is hard to say that the parameters of the control system are optimized which can be set to any values.

The same problem occurs in an existing control system of which some control parameters are adjustable. That is, it is hard to say that the variable control parameters of the control system are optimized in adjusting the capability of the control system.

Furthermore, some control system has a plurality of evaluation standards for the capability thereof, which are not compatible with each other. In this case, the prior art method makes the optimization problem a single-objective one by assigning a trade-off ratio to each of the plurality of evaluation standards in order to try to optimize the control parameters.

However, it is usually difficult and a burden on the designer to determine optimum trade-off ratios for the plurality of evaluation standards.

### SUMMARY OF THE INVENTION

This invention was made under such circumstances, and a first purpose of this invention is to provide a design method for designing an optimized control system in terms of given control capability.

A second purpose of this invention is to provide an optimized control system in terms of given control capability.

A third purpose of this invention is to provide an adjustment method for optimizing a control system in terms of given control capability.

A fourth purpose of this invention is to provide an exposure method and exposure apparatus that can improve throughput and exposure accuracy.

According to a first aspect of this invention, there is provided a first design method with which to design a control system that controls an object to be controlled, the design method comprising: providing a control system model having a continuously variable parameter for the control system; providing at least one evaluation function that evaluates capability of the control system and where a unimodal is not guaranteed when the continuously variable parameter varies; and obtaining a value of the continuously variable parameter at which the evaluation function takes on an optimal value.

According to this, a control system model is assumed in designing the control system, and using such an evaluation function that its having unimodal when a continuously variable parameter of the control system model varies is not guaranteed, the capability of the control system is evaluated in order to obtain a globally optimum solution of the continuously variable parameter. In this way, a globally optimum solution of the continuously variable parameter can be obtained. Therefore, the control system optimized in terms of the capability can be designed.

In the first design method according to this invention, in the obtaining of a value of the continuously variable parameter, an optimal solution of the continuously variable parameter may be obtained by using a genetic algorithm. In this case, because a genetic algorithm is used which is suitable for global optimization, an optimal solution of the continuously variable parameter can be obtained easily and swiftly.

According to a second aspect of this invention, there is provided a second design method with which to design a control system that controls an object to be controlled, the design method comprising: providing a control system model having a continuously variable parameter for the control system; providing a plurality of evaluation functions that evaluate capability of the control system and that vary independently of each other when the continuously variable parameter varies; and obtaining a value of the continuously variable parameter at which the plurality of evaluation functions take on respective optimal values simultaneously.

According to this, by optimizing simultaneously a plurality of evaluation functions that evaluate capability of the control system and that vary independently of each other when the continuously variable parameter varies, an optimum solution of the continuously variable parameter is obtained, the optimizing being called multi-objective optimization. Therefore, the control system optimized in terms of given capability can be designed.

In the second design method according to this invention, in at least one of the plurality of evaluation functions a unimodal may not be guaranteed when the continuously variable parameter varies.

Furthermore, in the second design method according to this invention, in the obtaining of a value of the continuously variable parameter, an optimal solution of the continuously variable parameter can be obtained by using a genetic algorithm. In this case, because a genetic algorithm is used which is suitable for multi-objective optimization, an optimal solution of the continuously variable parameter can be obtained easily and swiftly.

Here, when the control system model has a plurality of continuously variable parameters, in obtaining values of the plurality of continuously variable parameters, a plurality of Pareto optimal solutions of a group of the plurality of continuously variable parameters can be obtained simultaneously. Here, a Pareto optimal solution means a solution at which at least one of the evaluation functions is optimized among solutions whose values are substantially the same for the other evaluation functions. In this case, a group of Pareto optimal solutions, i.e. optimal solutions obtained by changing trade-off ratios, are obtained without depending on initial values.

In the first and second design methods according to this invention, the object to be controlled may be a stage on which a body is mounted, and the control system may be a stage control system that drives and controls the stage. In this case, optimal solutions can be obtained for design parameters of a control system model of the stage control system such as the position-loop gain and speed-loop gain, the optimal solutions optimizing the capability of the control system such as the accuracy of positioning and the time required for positioning. Therefore, the control system having the design parameters optimized in terms of the capability can be designed.

According to a third aspect of this invention, there is provided a control system designed by using the design method according to this invention. According to this, because design parameters of a control system model are optimized in terms of given capability by using the design method of this invention, an object to be controlled can be controlled with the given capability improved.

According to a fourth aspect of this invention, there is provided a first adjustment method with which to adjust a control system that controls an object to be controlled and that has a continuously variable parameter, the adjustment method comprising: providing at least one evaluation function that evaluates capability of the control system and where a unimodal is not guaranteed when the continuously variable parameter varies; obtaining a value of the continuously variable parameter at which the evaluation function takes on an optimal value; and setting the continuously variable parameter to the value obtained.

According to this, using such an evaluation function that its having unimodal when each of at least one continuously variable parameter of an actual control system varies is not guaranteed, the capability of the control system is evaluated in order to obtain a globally optimum solution of the continuously variable parameter. In this way, a globally optimum solution of the continuously variable parameter can be obtained. Therefore, the control system can be adjusted and optimized in terms of the capability.

In the first adjustment method with which to adjust a control system according to this invention, in the obtaining of a value of the continuously variable parameter, an optimal solution of the continuously variable parameter may be obtained by using a genetic algorithm. In this case, because a genetic algorithm is used which is suitable for global optimization, an optimal solution of the continuously variable parameter can be obtained easily and swiftly.

According to a fifth aspect of this invention, there is provided a second adjustment method with which to adjust a control system that controls an object to be controlled and that has a continuously variable parameter, the adjustment method comprising: obtaining an optimal value on design of the continuously variable parameter, using the design method according to this invention; obtaining a value of the continuously variable parameter, within a given range including the optimal value on design of the continuously variable parameter, at which the evaluation function takes on an optimal value in controlling an object to be controlled via the control system; and setting the continuously variable parameter to the value obtained in the obtaining of a value of the continuously variable parameter.

According to this, in a control system designed using the first design method for designing a control system, the range of the continuously variable parameters for searching for the optimum solutions thereof is limited to a given range where optimum values on design of the continuously variable parameters exist and which is in accord with the difference between the control model and the actual control system. And the values of the continuously variable parameters within the range that optimizes (minimizes or maximizes) the value of the evaluation function are obtained, and the continuously variable parameters of the control system are set to the values obtained. Therefore, the optimum solutions of the continuously variable parameters of the actual control system are swiftly obtained, and the given capability of the control system can be swiftly adjusted.

In the second adjustment method with which to adjust a control system according to this invention, in the obtaining of a value of the continuously variable parameter, an optimal solution of the continuously variable parameter of the control system may be obtained by using a genetic algorithm. In this case, because a genetic algorithm is used which is suitable for global optimization, even if the evaluation function having unimodal when the continuously variable parameter varies within the given range is not guaranteed, an optimal solution of the continuously variable parameter can be obtained easily and swiftly.

According to a sixth aspect of this invention, there is provided a third adjustment method with which to adjust a control system that controls an object to be controlled and that has a continuously variable parameter, the adjustment method comprising: providing a plurality of evaluation functions that evaluate capability of the control system and that vary independently of each other when the continuously variable parameter varies; obtaining a value of the continuously variable parameter at which the plurality of evaluation functions take on respective optimal values simultaneously; and setting the continuously variable parameter to the value obtained.

According to this, in a control system designed using the second design method for designing a control system, the range of the continuously variable parameters for searching for the optimum solutions thereof is limited to a given range where optimum values on design of the continuously variable parameters exist and which is in accord with the difference between the control model and the actual control system. And the values of the continuously variable parameters within the range that optimizes (minimizes or maximizes) the value of the evaluation function are obtained, and the continuously variable parameters of the control system are set to the values obtained. Therefore, the optimum solutions of the continuously variable parameters of the actual control system are swiftly obtained, and the given capability of the control system can be swiftly adjusted.

In the third adjustment method with which to adjust a control system according to this invention, in at least one of the plurality of evaluation functions a unimodal may not be guaranteed when the continuously variable parameter varies.

Furthermore, in the third adjustment method of this invention, in the obtaining of a value of the continuously variable parameter, an optimal solution of the continuously variable parameter can be obtained by using a genetic algorithm. In this case, because a genetic algorithm is used which is suitable for multi-objective optimization, an optimal solution of the continuously variable parameter can be obtained easily and swiftly.

Here, when the control system has a plurality of continuously variable parameters, in the obtaining of values of the plurality of continuously variable parameters, a plurality of Pareto optimal solutions of a group of the plurality of continuously variable parameters can be obtained simultaneously. In this case, a group of Pareto optimal solutions, i.e. optimal solutions obtained by changing trade-off ratios, are obtained without depending on initial values.

According to a seventh aspect of this invention, there is provided a fourth adjustment method with which to adjust a control system that controls an object to be controlled and that has a continuously variable parameter, the adjustment method comprising: obtaining an optimal value on design of the continuously variable parameter, using the second design method; obtaining a value of the continuously variable parameter, within a given range including the optimal value on design of the continuously variable parameter, at which the plurality of evaluation functions simultaneously take on respective optimal values in controlling an object to be controlled via the control system; and setting the continuously variable parameter to the value obtained in the obtaining of a value of the continuously variable parameter.

According to this, in a control system designed using the second method for designing a control system, the range of the continuously variable parameters for searching for the optimum solutions thereof is limited to a given range where optimum values on design of the continuously variable parameters exist and which is in accord with the difference between the control model and the actual control system. And the values of the continuously variable parameters within the range that optimizes (minimizes or maximizes) the value of the evaluation function are obtained, and the continuously variable parameters of the control system are set to the values obtained. Therefore, the optimum solutions of the continuously variable parameters of the actual control system are swiftly obtained, and the given capability of the control system can be swiftly adjusted.

In the fourth adjustment method with which to adjust a control system according to this invention, in the obtaining of a value of the continuously variable parameter, an optimal solution of the continuously variable parameter can be obtained by using a genetic algorithm. In this case, because a genetic algorithm is used which is suitable for multi-objective optimization, an optimal solution of the continuously variable parameter can be obtained easily and swiftly.

Here, when the control system has a plurality of continuously variable parameters, in the obtaining of values of the plurality of continuously variable parameters, a plurality of Pareto optimal solutions of a group of the plurality of continuously variable parameters can be obtained simultaneously. In this case, a group of Pareto optimal solutions, i.e. optimal solutions obtained by changing trade-off ratios, are obtained without depending on initial values.

In the first to fourth adjustment methods according to this invention, the object to be controlled may be a stage on which a body is mounted, and the control system may be a stage control system that drives and controls the stage. In this case, optimal solutions can be obtained for design parameters of a control system model of the stage control system such as the position-loop gain and speed-loop gain, the optimal solutions optimizing the capability of the control system such as the accuracy of positioning and the time required for positioning. Therefore, the control system can be optimized in terms of the capability.

According to an eighth aspect of this invention, there is provided a first exposure method comprising: providing the control system of this invention serving as a stage control system that controls movement of a stage on which a body to be positioned in a path of an exposure beam is mounted; and radiating an exposure beam while controlling the stage via the stage control system. According to this, the control system of this invention optimized in terms of given capability is used as a control system that controls movement of an object to be moved upon exposure. Therefore, exposure can be performed with a balance between swiftness and high accuracy.

According to a ninth aspect of this invention, there is provided a second exposure method comprising: adjusting a stage control system that controls movement of a stage on which a body to be positioned in a path of an exposure beam is mounted, by using any of the first to fourth adjustment methods; and radiating an exposure beam while controlling the stage via the stage control system adjusted in the adjusting. According to this, a control system that controls movement of an object to be moved upon exposure is adjusted and optimized in terms of given capability by using any of the first to fourth adjustment methods. Therefore, exposure can be performed with a balance between swiftness and high accuracy.

In the first and second exposure methods according to this invention, the body may be a substrate that is exposed to the exposure beam. In this case, because the stage on which the substrate subject to exposure is mounted is controlled by the control system optimized in terms of the capability of the stage such as the accuracy of positioning. Therefore, the throughput and accuracy of exposure can be improved.

According to a tenth aspect of this invention, there is provided an exposure apparatus that transfers a predetermined pattern onto a substrate by illuminating the substrate with an exposure beam, the exposure apparatus comprising: a beam source that generates the exposure beam; and the control system of this invention that drives and controls a stage on which the substrate is mounted.

According to this, the control system of this invention optimized in terms of given capability is used as a control system that controls movement of an object to be moved upon exposure. Therefore, exposure can be performed with a balance between swiftness and high accuracy.

### BRIEF DESCRIPTION OF THE DRAWINGS

FIG. 1 is a schematic view showing an exposure apparatus according to an embodiment of this invention;

FIG. 2 is a block diagram showing the structure of a main controller in FIG. 1;

FIG. 3 is a block diagram showing the structure of a stage controller in FIG. 1;

FIG. 4 is a block diagram showing an exemplary structure of a stage control system of the exposure apparatus in FIG. 1;

FIG. 5 is a flow chart for explaining the process of optimizing variable parameters of the stage control system in the first embodiment;

FIG. 6 is a flow chart for explaining the process of optimizing variable parameters of the control model of the stage control system in the first embodiment;

FIGS. 7A and 7B are views for explaining a target track supplied to the stage control system in order to evaluate the capability;

FIG. 8 is a flow chart for explaining the process of searching for optimum values of the variable parameters of a control model, using a genetic algorithm;

FIG. 9 is a view illustrating alternation of generations in a genetic algorithm;

FIGS. 10A to 10F are views for explaining crossover in the genetic algorithm;

FIG. 11 is a flow chart for explaining the process of optimizing variable parameters of the stage control system in the first embodiment;

FIG. 12 is a flow chart for explaining the process of optimizing variable parameters of a stage control system in the second embodiment;

FIG. 13 is a view illustrating alternation of generations by non-Pareto optimal selection strategy in a genetic algorithm;

FIG. 14 is a graph showing an example of Pareto optimal selections; and

FIG. 15 is a flow chart for explaining the process of optimizing variable parameters of a stage control system in the second embodiment.

### DETAILED DESCRIPTION OF THE PREERRED EMBODIMENTS

<<A First Embodiment>>

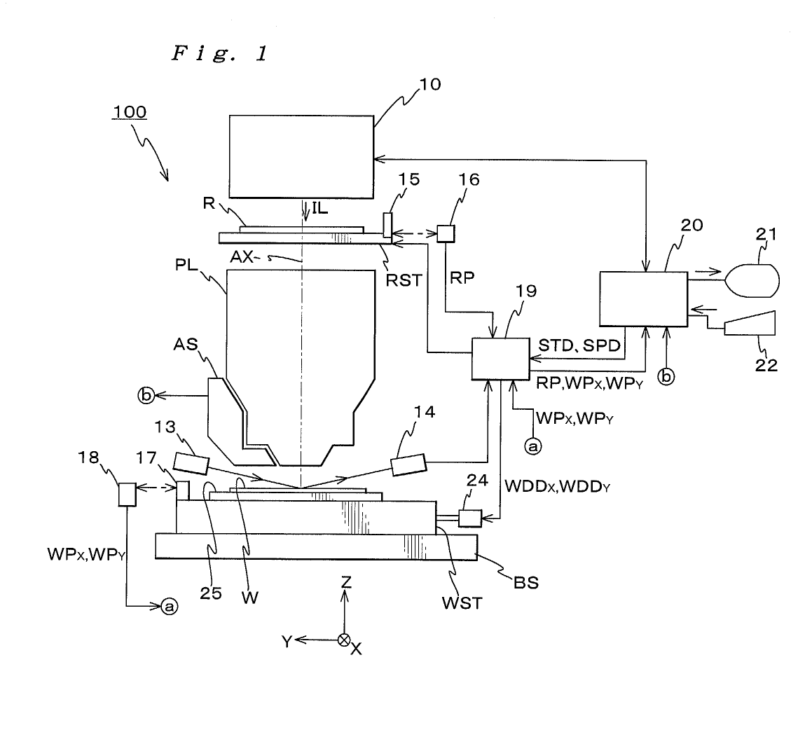

A first embodiment of the present invention will be described below with reference to FIGS. 1 to 11.

FIG. 1 shows the schematic view of an exposure apparatus 100 of the first embodiment according to this invention. The exposure apparatus 100 is a projection exposure apparatus of a step-and-scan method. The exposure apparatus 100 comprises an illumination system 10, a reticle stage RST holding a reticle R as a mask, a projection optical system PL, a wafer stage WST on which a wafer as a substrate is mounted, a stage controller 19 as a control system, a main controller 20 that controls the whole apparatus and the like.

The illumination system 10 comprises, a light source, an illuminance uniformization optical system including a fly-eye lens and the like, a relay lens, a variable ND filter, a reticle blind, a dichroic mirror, and the like (none are shown) as disclosed in, for example, in Japanese Patent Laid-Open No. 10-112433 and U.S. Pat. No. 6,038,013 corresponding thereto. The disclosure in the above Japanese Patent Laid-Open and U.S. Patent is incorporated herein by reference. The illumination system 10 illuminates a slit-shaped illumination area, on a retcile R on which a circuit pattern is formed, defined by the reticle blind with illumination light IL and with almost uniform illuminace.

On the reticle stage RST the reticle R is fixed by, for example, vacuum chucking. The reticle stage RST can be finely driven in two dimensions along an X-Y plane perpendicular to the optical axis (coinciding with the optical axis AX of the projection optical system PL described later) of the illumination system 10 by a reticle-stage-drive portion (not shown) in order to position the reticle R and can also be driven in a predetermined scan direction (herein, the Y-direction) at a specified scan speed. In this embodiment, the reticle stage RST can also be finely driven in a Z-direction.

The position of the reticle stage RST is always detected with a resolving power of, e.g., about 0.5 to 1 nm through a movable mirror 15 by a reticle laser interferometer (hereinafter, referred to as a reticle interferometer) 16, and the position information of the reticle stage RST is sent from the reticle interferometer 16 to the stage controller 19. And according to the position information the stage controller 19 drives the reticle stage RST via the reticle-stage-drive portion (not shown). It is remarked that the position information of the reticle stage RST is sent through the stage controller 19 to the main controller 20.

The projection optical system PL, of which the optical axis AX is parallel to the Z-axis direction, is disposed below the reticle stage RST in FIG. 1 and is a refraction optical system which is telecentric on both sides and which has a predetermined projection ratio of, e.g., 1/5, 1/4, or 1/6. Therefore, when the illumination area of the reticle R is illuminated with illumination light IL from the illumination system 10, the reduced image (partially inverted image) of the illuminated part of a circuit pattern on the reticle R is transferred onto an exposure area on the wafer W coated with a resist (photosensitive material) through the projection optical system PL by the illumination light IL having passed through the reticle R.

The wafer stage WST is disposed on a base BS below the projection optical system PL in FIG. 1, and a wafer holder 25 is mounted on the wafer stage WST. On the wafer holder 25, a wafer W is fixed via, for example, vacuum chuck. The wafer holder 25 can be tilted, in any direction, relative to a plane perpendicular to the optical axis of the projection optical system PL by a drive portion (not shown), be finely driven parallel to the optical axis AX of the projection optical system PL (the Z-direction), and can also be finely rotated about the optical axis AX.

The wafer stage WST is constructed to be able to move not only in the scan direction (Y-direction) but also in a direction (an X-direction) perpendicular to the scan direction in order to position a plurality of shot areas on the wafer in the exposure area conjugate to the illumination area, and the step-and-scan sequence is performed where the scan-exposure operation of a shot area on the wafer and the moving of a next shot to a scan start position for exposure are repeated. The wafer stage WST is driven in two dimensions via a wafer-stage-drive portion 24 including a motor and the like.

The position of the wafer stage WST in the X-Y plane is always detected with a resolving power of, e.g., about 0.5 to 1 nm through a movable mirror 17 by a wafer laser interferometer 18, and the position information WP (WP_{X}, WP_{Y}) of the wafer stage WST is sent to a stage controller 19, and according to the position information WP the stage controller 19 drives the wafer stage WST. It is remarked that the position information WP (WP_{X}, WP_{Y}) of the reticle stage RST is sent through the stage controller 19 to the main controller 20.

In addition, fixed on the wafer stage WST is a reference mark plate (not shown) on which various marks are formed, for example, for base-line measurement which measures the distance between the detection center of an alignment microscope AS described later and the optical axis AX.

The alignment microscope AS is an alignment sensor of an off-axis method disposed on the side face of the projection optical system PL, and supplies pick-up results of an alignment mark (wafer mark) on each shot area of the wafer W and the reference marks of the reference mark plate to the main controller 20.

Note that as a method (alignment method) of detecting alignment marks, not being limited to the pickup method described in this embodiment, another detection method may be employed such as a so-called Laser Interferometic Alignment (LIA) method which, by receiving light diffracted by an alignment mark, detects the position deviation of the alignment mark based on the diffracted light, as disclosed in U.S. Pat. No. 6,034,378 and WO98/39689, or a so-called Laser Step Alignment (LSA) method which detects the position of an alignment mark based on the intensity of diffracted light by the alignment mark.

Furthermore, fixed on a support portion (not shown) supporting the projection optical system PL in the exposure apparatus 100 is a multi-focal position detection system of an obliquely-incident-light method comprising: a illumination optical system 13 for supplying imaging beams, which form a plurality of slit-images, in an oblique direction relative to the optical axis AX and toward the best imaging plane of the projection optical system PL; and a light-receiving optical system 14 for receiving, through respective slits, these imaging beams reflected by the surface of the wafer W. As the multi-focal position detection system (13, 14), one having the same structure as disclosed in, for example, Japanese Patent Laid-Open No. 5-190423 and U.S. Pat. No. 5,502,311 corresponding thereto is used, of which the disclosure is incorporated herein by reference, and according to the wafer's position information from the multi-focal position detection system (13, 14), the stage controller 19 moves the wafer holder 25 in the Z-direction and tilts it.

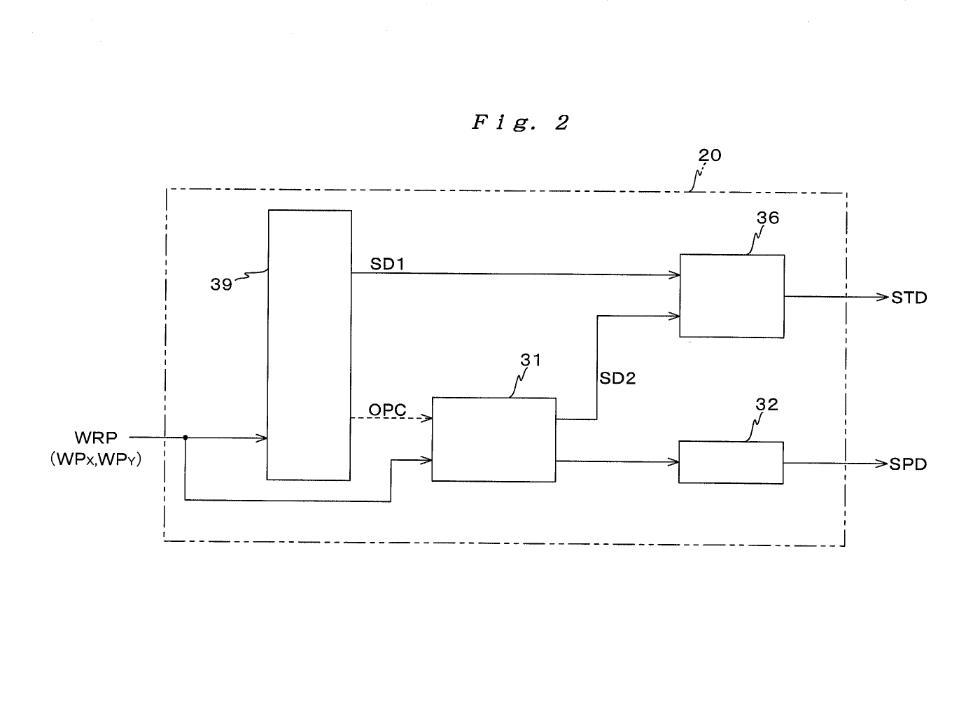

The main controller 20, as shown in FIG. 2, comprises a controller 39 for controlling the exposure apparatus 100 overall, a parameter-optimizing unit 31 for calculating the optimum value of a parameter of the stage controller 19, and an optimum-value setting unit 32 for supplying parameter-value SPD calculated by the optimizing unit 31 to the stage controller 19. Furthermore, the main controller 20 further comprises a track-calculation unit 36 for calculating target positions at each point of time based on track conditions (e.g. initial position (and initial speed), final position (and final speed), etc.) of the reticle stage RST and the wafer stage WST sent from the controller 39 or parameter-optimizing unit 31. It is noted that target-position information STD calculated by the track-calculation unit 36 is sent to the stage controller 19. Moreover, the main controller 20 is connected to a display unit 21 and an input unit 22 (refer to FIG. 1).

Although, in this embodiment, the main controller 20 comprises various units as describe above, the main controller 20 may be a computer system which executes computer programs for performing functions of the various units.

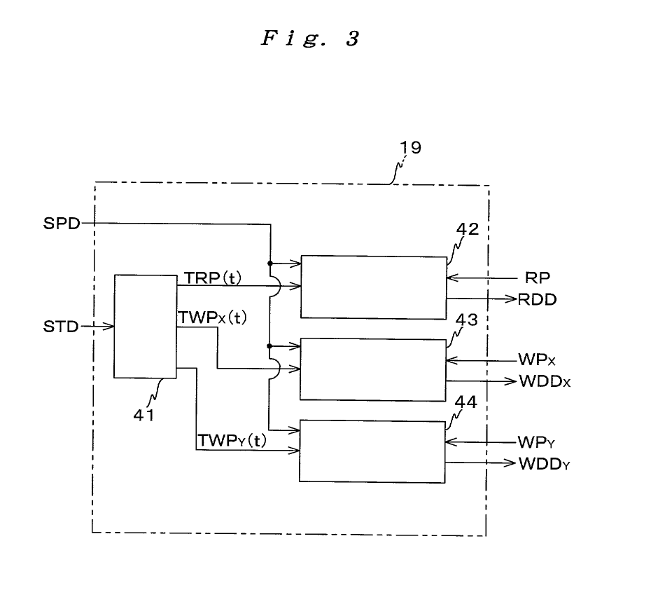

As shown in FIG. 3, the stage controller 19 comprises a target-track generation unit 41 that generates, at each point of time, the target position (Y position) TRP(t) of the reticle stage RST (where t denotes time; hereinafter, referred to as the “target track TRP(t)”), the target X-position TWP_{X}(t) of the wafer stage WST (hereinafter, referred to as the “target track TWP_{X}(t)”) and the target Y-position TWP_{Y}(t) of the wafer stage WST (hereinafter, referred to as the “target track TWP_{Y}(t)”) based on the target-position information STD sent from the main controller 20; a reticle-position-control portion 42; a wafer-X-position-control portion 43; and a wafer-Y-position-control portion 44. The reticle-position-control portion 42 controls the position of the reticle stage RST via a reticle-drive portion based on the target track TRP(t) and position information RP from the reticle interferometer 16. Moreover, the wafer-X-position-control portion 43 and wafer-Y-position-control portion 44 control the position of the wafer stage WST via the wafer-drive portion 24 by sending drive-instruction data WDD (WDD_{X}, WDD_{Y}) based on the target track TWP_{X}(t), the target track TWP_{Y}(t), and X- and Y-position information WP_{X}, WP_{Y} from the wafer interferometer 18.

It is noted that each of the reticle-position-control portion 42, the wafer-X-position-control portion 43 and wafer-Y-position-control portion 44 has control-parameters that can be set according to the parameter value SPD from the main controller 20.

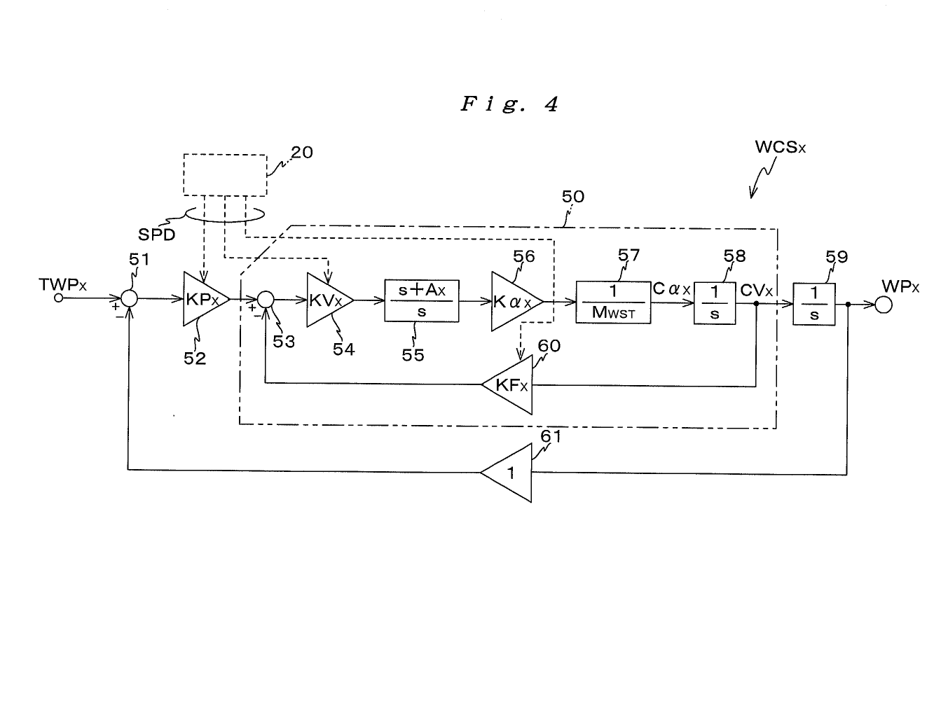

The control system WCS_{X} of the wafer-X-position-control portion 43 is shown in FIG. 4, representing the control systems that control the positions of the reticle stage RST and the wafer stage WST and that include the reticle-position-control portion 42, the wafer-X-position-control portion 43 and the wafer-Y-position-control portion 44.

As shown in FIG. 4, the control system WCS_{X} comprises (a) a subtracter 51 for calculating position-deviation, i.e. the difference between the target track TWP_{X}(t) and position information WP_{X} that is the output of an integrator 59 described later and that represents the actual position of the wafer stage WST given by the wafer interferometer 18, (b) a conversion-amplifier 52 for converting the position-deviation outputted by the subtracter 51 into a speed value (amplification factor=KP_{X}). And the control system WCS_{X} further comprises (c) a speed-control portion 50 for controlling the speed to become equal to the speed value (target value) outputted by the conversion-amplifier 52, (d) the integrator 59 for integrating the speed values outputted by the speed-control portion 50. Here, the position information signal from the integrator 59 is amplified one time the original amplitude by an amplifier 61 and feed-backed to the subtracter 51 so as to form a position control loop.

The speed-control portion 50 comprises (a) a subtracter 53 for calculating speed-deviation, i.e. the difference between the speed value outputted by the conversion-amplifier 52 and the value outputted by an amplifier 60 described later, (b) a conversion-amplifier 54 for amplifying the speed-deviation outputted by the subtracter 53 (amplification factor=KV_{X}). And the speed-control portion 50 further comprises (c) a PI portion 55 for converting the value outputted by the conversion-amplifier 54 into an acceleration value (corresponding to the drive signal WDD_{X}) by taking (input)×(s+Ax)/s, (d) a conversion-amplifier 56 for converting the acceleration value outputted by the PI portion 55 into a thrust value (amplification factor=Kα_{X}; denoting the wafer-drive portion 24). And the speed-control portion 50 even further comprises (e) a converter 57 for converting the thrust value outputted by the conversion-amplifier 56 into an acceleration value (conversion factor=M_{WST}; denoting the wafer stage WST), (f) an integrator 58 for integrating the acceleration values outputted by the converter 57 to produce a speed value, and the speed value outputted by the integrator 58 is amplified by an amplifier 60 (amplification factor=KF_{X}) and feed-backed to the subtracter 53 so as to form a speed control loop.

That is, the control system WCS_{X} in FIG. 4 is a position control system constituted by a multi-loop control system including the speed control loop as an internal loop of the position control loop.

Moreover, the amplification factor KP_{X} of the conversion-amplifier 52, the amplification factor KV_{X} of the conversion-amplifier 54 and the amplification factor KF_{X} of the amplifier 60 are constructed to be set by the main controller 20. That is, the main controller 20 sends data SPD containing the amplification factors KP_{X}, KV_{X}, KF_{X} to set them.

It is noted that the subtracter 51, the conversion-amplifier 52, the subtracter 53, the conversion-amplifier 54, the PI portion 55, the converter 59 and the amplifier 60 are arranged in the wafer-X-position-control portion 43, to function as described above. The functions of the integrators 58, 59 are implemented by the wafer interferometer 18 of the wafer-X-position-control portion 43 and a differentiator (not shown) performing differentiation on the position information WP_{X} from the wafer interferometer 18.

Although the structures of the wafer-X-position-control portion 43 and the control system WCS_{X} related thereto have been described above, the reticle-position-control portion 42 and a control system related thereto, and the wafer-Y-position-control portion 44 and a control system related thereto are constructed likewise. Hereinafter, the reticle-position-control portion 42 and the control system related thereto are referred to as a control system RCS, and the wafer-Y-position-control portion 44 and the control system related thereto are referred to as a control system WCS_{Y}.

Next, the adjustment of the control systems RCS, WCS_{X}, WCS_{Y} for controlling the positions of the reticle stage RST and the wafer stage WST, i.e. the optimization of control parameters, in this embodiment will be described below, taking the control system WCS_{X} as an example. In such adjustment of the control system WCS_{X}, the amplification factors KP_{X}, KV_{X}, KF_{X} are optimized which are control parameters that can be set.

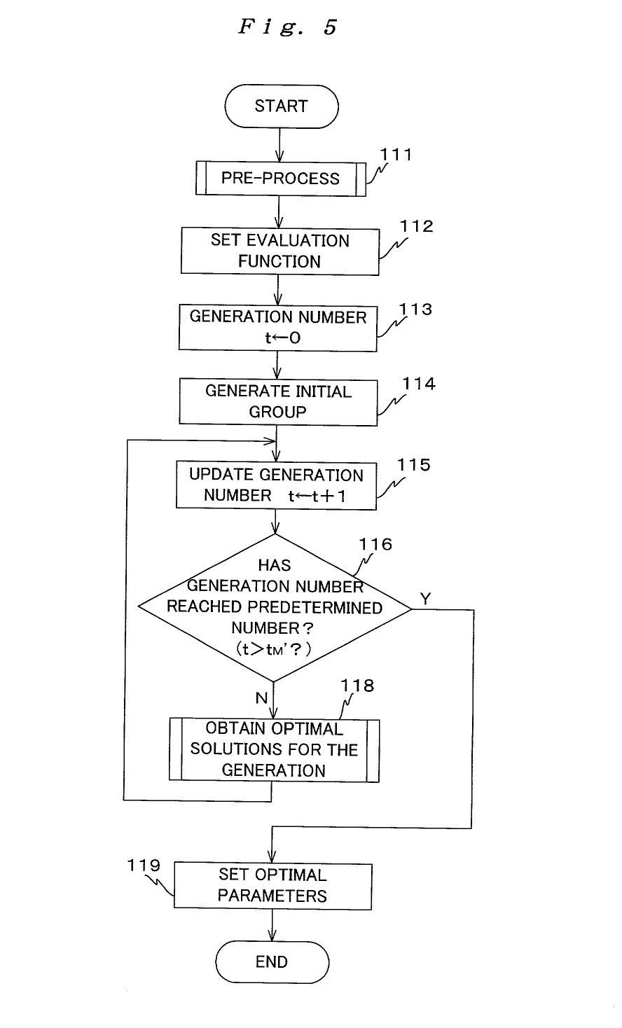

In the optimization, first, a subroutine 111 of FIG. 5 performs a pre-process for obtaining the range in which optimum values of the amplification factors KP_{X}, KV_{X}, KF_{X} are present.

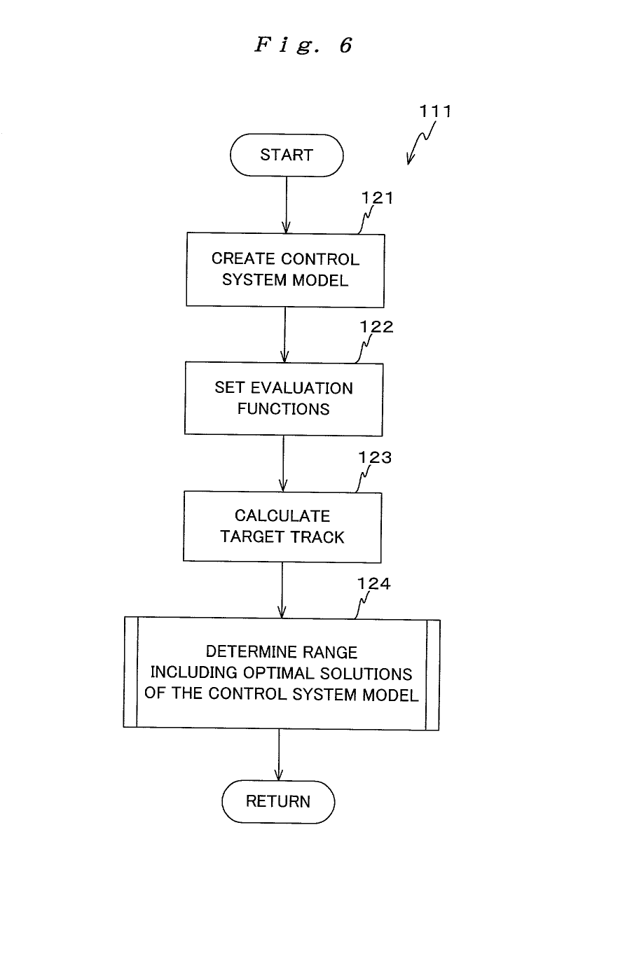

In a step 121 of the subroutine 111 in FIG. 6, the parameter-optimizing unit 31 creates a control-system model in agreement with the control system WCS_{X} in FIG. 4. The control-system model contains the amplification factors KP_{X}, KV_{X}, KF_{X} of which the values are to be determined, the constant Ax that is a constant determined by the structure of the PI portion 55, and the amplification factor Kα_{X} that is a constant determined by the structure of the wafer-drive portion 24.

Next, in a step 122 in FIG. 6, the parameter-optimizing unit 31 creates an evaluation function to evaluate the capability of the control system WCS_{X}. Generally, the capability of the control system WCS_{X} is evaluated, for a given target track TWP_{X}(t) from a start-X-position to a target-final-X-position of the wafer stage, in how accurately the wafer stage can be positioned in the target-final-X-position and how short the time from starting to move in the start-X-position X_{S} through converging on a final-X-position is. That is, the capability of the control system WCS_{X} being high means that the positioning error |ΔX| relative to the target-final-X-position is small and that the time T for converging on the final-X-position X_{E} is short. Therefore, in this embodiment an evaluation function is given by the function

F(KP_{X}, KV_{X}, KF_{X})=|ΔX|+K×T (1),

where K is a constant weight factor denoting the weight of the time T relative to the error |ΔX| and which is also referred to as the “evaluation function F” hereinafter.

Then in a step 123 the target track TWP_{X}(t) is obtained to use for evaluating the capability of the control-system model.

In obtaining the target track TWP_{X}(t), first, the parameter-optimizing unit 31 determines an X-position X_{S} at an acceleration-start time t_{S} and a target-X-position X_{E} at an acceleration-completion time t_{E} and sets speed V_{S} and acceleration α_{S} at the time t_{S}, and speed V_{E} and acceleration α_{E} at the time t_{E} all to 0 m/s and Om/s². That is, it is considered that the wafer stage WST staying in the start-X-position X_{S} starts to move and stops in the target-X-position X_{E}.

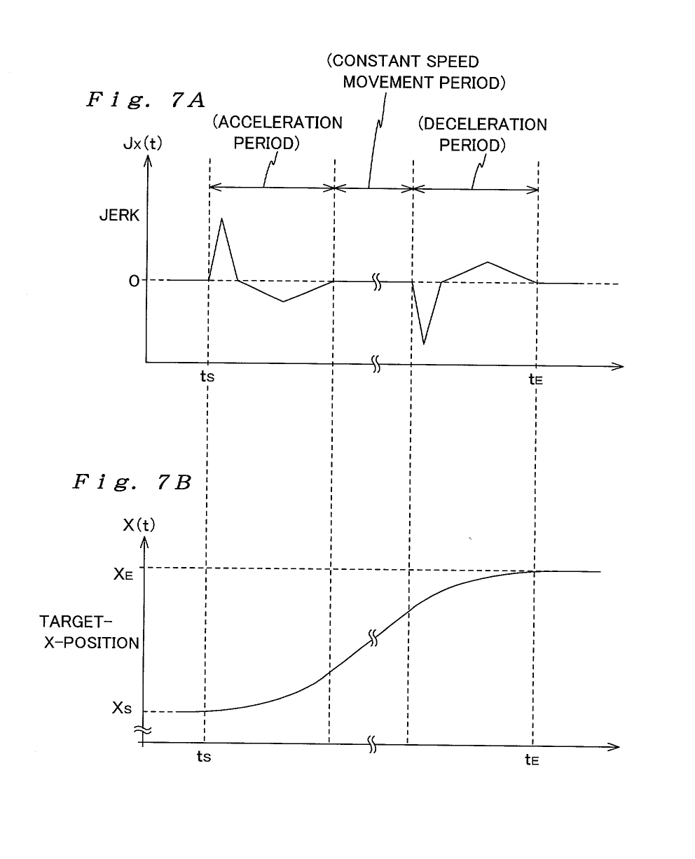

Next, in order to suppress the vibration of the wafer stage WST at the end of acceleration from the state of staying to the state of moving at a constant speed and at the end of deceleration from the state of moving at the constant speed to the state of staying, the target track TWP_{X}(t) is calculated where the acceleration, i.e., the jerk of the wafer stage WST varies with time in the way shown in FIG. 7. That is, conditions for calculating the target track TWP_{X}(t) are that the jerk varies with time in the way shown in FIG. 7A and that the above boundary conditions are met. The target track TWP_{X}(t) calculated in this manner is shown in FIG. 7B.

Then in a subroutine 124, by inputting the target track TWP_{X}(t) calculated into the control-system model created in the step 121, the values of the amplification factors KP_{X}, KV_{X}, KF_{X}, optimum solutions, which minimize the value of the evaluation function F are calculated. Note that in this embodiment a genetic algorithm is used to search for and obtain the optimum solutions. The reason why a genetic algorithm is used is that the evaluation function F having a single bottom (unimodal) when variables KP_{X}, KV_{X}, KF_{X} change is not guaranteed because the amplification factors KP_{X}, KV_{X}, KF_{X} are expected to contribute dependently of each other to the variation of the evaluation function F's value. That is, a global search is needed to search for the optimum solutions of the variables KP_{X}, KV_{X}, KF_{X} that minimize the evaluation function F.

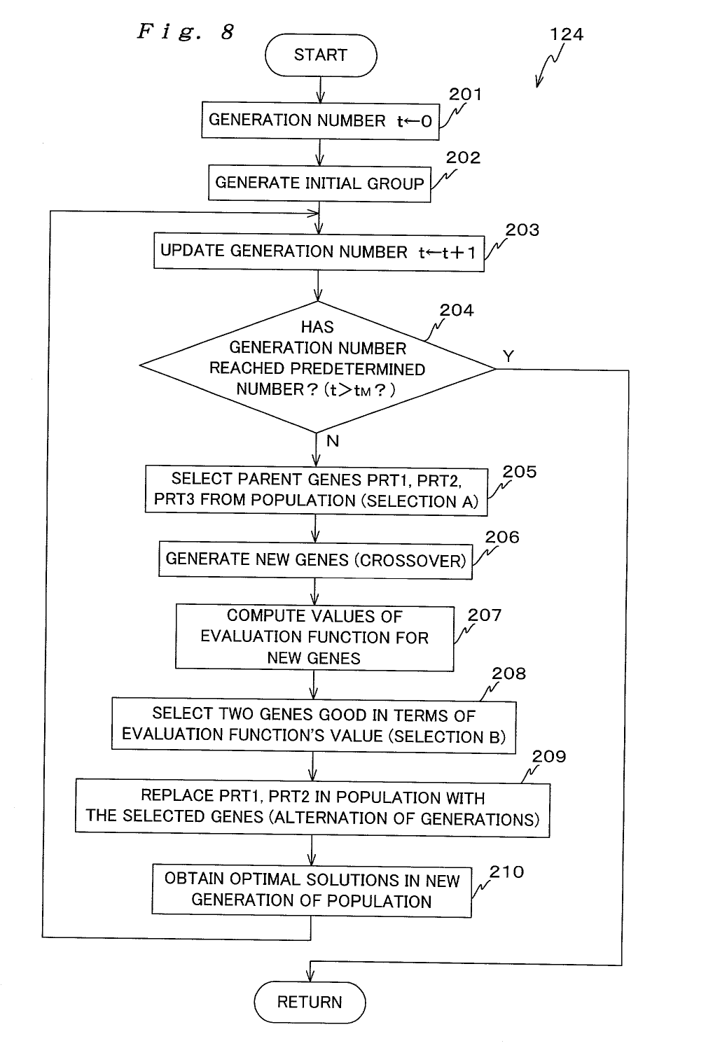

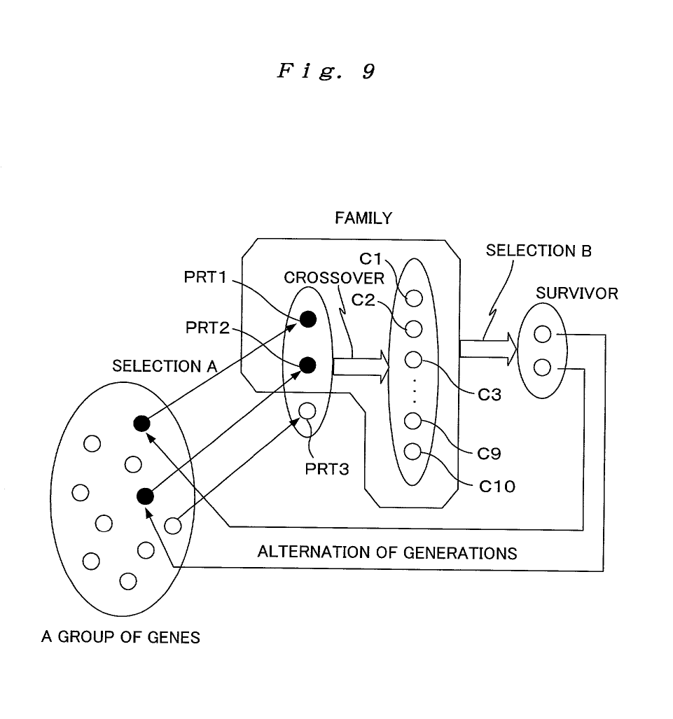

Next, the search for the optimum solutions of the variables KP_{X}, KV_{X}, KF_{X} in the subroutine 124 will be described with reference to a flow chart of FIG. 8 and FIGS. 9, 10A to 10F as needed. It is remarked that FIG. 9 illustrates the process where a group of genes, which is a group of solutions each corresponding to a gene in the genetic algorithm, changes into another group of genes including the optimum solutions and that the flow chart of FIG. 8 is a flow chart for implementing the process in FIG. 9. Furthermore, in the search by the genetic algorithm, an initial group is the first generation, and alternations of generations occur up to the t_{M}′th generation (e.g. t_{M}=100,000).

First, in a step 201 of FIG. 8 the ‘t’ is set to zero (the 0′th generation). Then in a step 202 the initial group of genes is generated which consists of a plurality of genes each of which contains random values of variables (KP_{X}, KV_{X}, KF_{X}). In this embodiment the initial group is composed of 40 genes. It is noted that when the number of genes in the initial group is larger, the possibility of finding out the optimum solutions in the global search becomes higher while the total computation amount becomes larger, and that when the number of genes in the initial group is smaller, the possibility of finding out the optimum solutions in the global search becomes lower while the total computation amount becomes smaller. And in a step 203 the ‘t’ is incremented (t=1; the first generation).

Next, a step 204 checks whether or not alternations of generations have occur up to the t_{M}′th generation. At this point of time, because the answer is NO, the sequence proceeds to a step 205. In the step 205, three parent genes PRT1, PRT2, PRT3 are randomly selected from the group of genes (population), as indicated by selection A in FIG. 9. In a step 206, ten child genes C1 to C10 are generated from the parent genes PRT1, PRT2, PRT3 by crossover. The crossover means that a child gene inheriting a feature from each parent gene is generated. A crossover operator is provided for each type of crossover.

Here, because each of the variables (KP_{X}, KV_{X}, KF_{X}) takes on any of continuous values, an appropriate type of crossover needs to be used. Used as a crossover operator for crossing over on continuous variables are UNDX (refer to “A Real Coded Genetic Algorithm for Function Optimization using Unimodal Distributed Crossover, I. Ono and S. Kobayashi, Proceeding of 7th International Joint Conference on Genetic Algorithms, pp. 246-253, 1997”) and BLX-α (refer to “Real-coded Genetic Algorithm and Interval-Schemata, L. J. Eshleman and J. D. Schaffer, Foundation of Genetic Algorithms, pp. 187-202, 1993”). In this embodiment UNDX is used as the crossover operator.

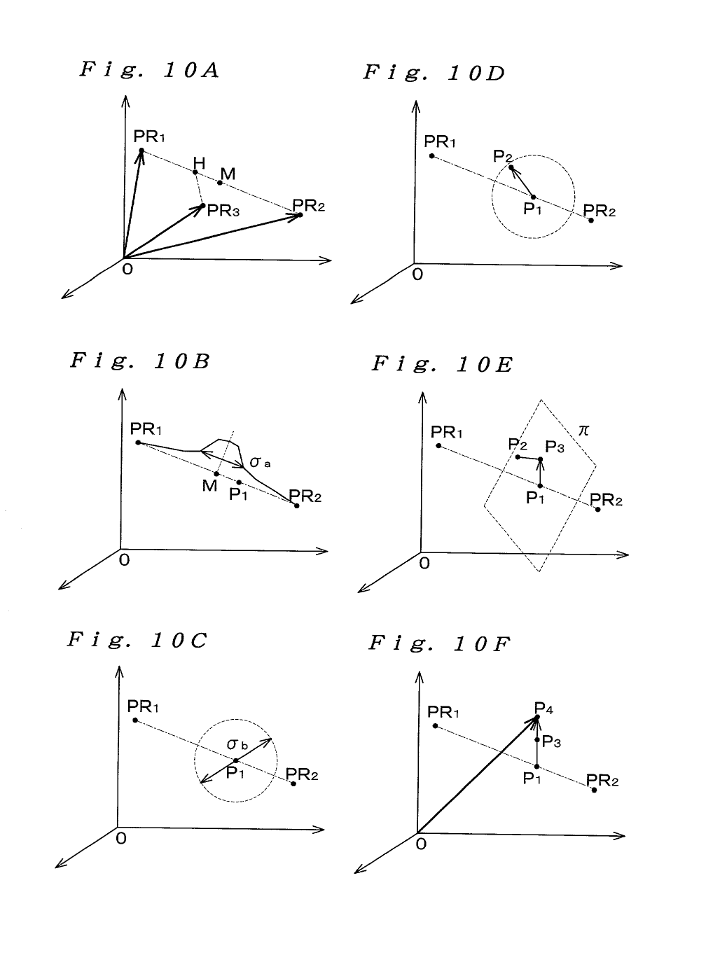

Hereinafter, the crossover in the step 206 will be described with reference to FIGS. 10A to 10F. In this embodiment because each gene has three elements, each gene is represented by a point in a three-dimensional vector space as illustrated in FIGS. 10A to 10F.

First, as shown in FIG. 10A, points PR₁, PR₂, PR₃ corresponding to the parent genes PRT1, PRT2, PRT3 are selected in the vector space; the middle point between points PR₁, and PR₂ is indicated by point M and the point at which a line through point PR₃ and perpendicular to a line segment PR₁-PR₂ crosses the line segment PR₁-PR₂ is indicated by point H.

Next, as shown in FIG. 10B, a point P₁ on the line segment PR₁-PR₂ is generated as a random number of a normal-distribution-random-number group where the point M is the expected value and where σₐ represents the standard deviation. And the σₐ is proportional to L₁₂ denoting the distance between points PR₁ and PR₂ and defined by the equation

σₐ=Cₐ×L₁₂ (2),

where Cₐ is an arbitrary constant. Note that if the Cₐ is larger, the total computation amount becomes larger while the possibility of finding out the optimum solutions in the global search becomes higher and that if the Cₐ is smaller, the total computation amount becomes smaller while the possibility of finding out the optimum solutions in the global search becomes lower.

The reason why the point M is used as the expected value is that the gene denoted by the point M reflects features of parent genes PRT1 and PRT2 equally. It is noted that the gene denoted by the point P₁ as shown in FIG. 10B reflects features of parent genes PRT1 and PRT2 in a proportion.

Next, as shown in FIG. 10C a three-dimensional space having a normal distribution of probability is considered which has the three normal-distribution-random variables and where the point P₁ is the expected value and where σ_{b} represents the standard deviation. And the σ_{b} is an arbitrary constant. Note that if the σ_{b} is larger, the total computation amount becomes larger while the possibility of finding out the optimum solutions in the global search becomes higher and that if the σ_{b} is smaller, the total computation amount becomes smaller while the possibility of finding out the optimum solutions in the global search becomes lower.

Subsequently, as shown in FIG. 10D, a point P₂ is generated as a normal-distribution random number in the three-dimensional space having the normal distribution of probability in FIG. 10C. It is noted that the gene denoted by the point P₂ reflects features of other parent genes as well as features of parent genes PRT1 and PRT2.

Next, as shown in FIG. 10E, a plane π through point P₁ and perpendicular to vector PR₁-PR₂ is considered, and the point at which a line through point P₂ and perpendicular to the plane π crosses the plane π is indicated by a point P₃. Subsequently, as shown in FIG. 10F, a point P₄ is generated as a random number of a normal-distribution-random-number group where the point P₁ is the expected value and where σ_{c} represents the standard deviation, the point P₄ being on the line extending from point P₁ and parallel to vector P₁P₃. Here, the σ, is proportional to the third root of L_{H3}, the L_{H3} denoting the distance between points H and PR₃ in FIG. 10A and defined by the equation

σ_{c}=C_{c}×L_{H3}^{⅓} (3)

where C_{c} is an arbitrary constant. Note that if the C_{c} is larger, the total computation amount becomes larger while the possibility of finding out the optimum solutions in the global search becomes higher and that if the C_{c} is smaller, the total computation amount becomes smaller while the possibility of finding out the optimum solutions in the global search becomes lower.

The gene denoted by the point P₄ reflects features of parent gene PR3 and other parent genes to a certain extent as well as features of both parent genes PRT1 and PRT2.

In the manner described above, the first crossover is performed, and a new gene, child gene C₁, denoted by the point P₄ is obtained. That is, the coordinate values of the point P₄ represent the values of the three variables (KP_{X}, KV_{X}, KF_{X}) of the child gene C₁.

After that, the crossover described above with reference to FIGS. 10A to 10F is repeated nine times so that ten child genes C1 to C10 can be generated in total.

Next, referring back to FIG. 8, in a step 207 for each of the parent genes PRT1, PRT2 and child genes C1 to C10, which are members of the family (refer to FIG. 9), the operation simulation of the control-system model is performed using the target track TWP_{X}(t), and based on the result of the simulation, the value of the evaluation function F is calculated.

Next, in a step 208, two good genes for which the evaluation function F's value is smaller are selected (selection B (screening) in FIG. 9). Subsequently, in a step 209 the parent genes PRT1, PRT2 of the group of genes are replaced with the two genes, which have survived in the selection of the step 208 (alternation of generations), and in a step 210 the best gene having the smallest value of the evaluation function F in the group of genes is obtained.

After the completion of the alternation of generations, the sequence proceeds to the step 203, and the new group of genes becomes the second generation (t←t+1). Next, the step 204 checks whether or not alternations of generations have occur up to the t_{M}′th generation.

After that, the steps 205 through 210 of the alternation of generations is repeated until the completion of alternations of generations up to the t_{M}′th generation, and if the answer in the step 204 is YES, the computation by the genetic algorithm ends.

The best solutions in the t_{M}′th generation obtained in this manner are the optimum solutions of the variables (KP_{X}, KV_{X}, KF_{X}). Note that if solutions having a smaller value of the evaluation function F than the best solutions have are needed, the genetic algorithm is performed using the t_{M}′th generation of genes as the initial group. That is because, in the search of optimum values by the genetic algorithm, the degree of being optimum increases as the alternation of generations occurs.

Then for each of various kinds of modeling errors between an actual control system WCS_{X} and the control-system model, the range where optimum values of the parameters (KP_{X}, KV_{X}, KF_{X}) for the actual control system WCS_{X} are supposed to exist and which includes optimum solutions for the control-system model of the control system WCS_{X} is determined. When the pre-process on the variable parameters of the control system WCS_{X} ends in this way, the process of the subroutine 111 ends, and the sequence returns to the main routine (step 112) in FIG. 5.

Next, in the step 112 of FIG. 5, according to instructions of the controller 39 the optimizing unit 31 sets the evaluation function F as a function for evaluating the capability of the control system WCS_{X}. This is because the purpose of adjustment for optimizing is to improve the capability of controlling the position of the wafer stage WST as in the above control-system model.

It is noted that in the adjustment for optimizing the variable parameters of the control system WCS_{X} in this embodiment, the same genetic algorithm as in the above control-system model is used to search for optimum values of the variable parameters. That is because, in the actual control system for controlling the position of the wafer stage WST, the evaluation function F having a single bottom (unimodal) when the variables KP_{X}, KV_{X}, KF_{X} change is not guaranteed, and thus a global search is needed to search for the optimum solutions.

Moreover, in the search of the optimum values of the variable parameters of the control system WCS_{X} by the genetic algorithm, an initial group is the first generation, and alternations of generations occur up to the t_{M}″th generation (e.g. t_{M}′=several tens to several hundred). The number of generations is smaller than that of the above control-system model. That is because while, in the case of the control-system model, optimum solutions for the actual control system WCS_{X} were searched for without any limitation on the range of values of the variable parameters, optimum solutions are searched for within the range where optimum values of the variable parameters are supposed to exist, which is obtained in the subroutine 111.

Next, in a step 113 the optimizing unit 31 sets the ‘t’ to zero (the 0′th generation).

In a step 114, the optimizing unit 31 generates the initial group which consists of a plurality of genes each of which contains random values of the variables (KP_{X}, KV_{X}, KF_{X}), which values are within the respective ranges obtained in the subroutine 111. Also in this embodiment the initial group is composed of 40 genes. For each of genes of the initial group the value of the evaluation function F is calculated in the following manner.

First, the optimizing unit 31 supplies the values of the variables (KP_{X}, KV_{X}, KF_{X}) that are elements of the gene to the optimum-value setting unit 32, and the optimum-value setting unit 32 supplies the values of the variables (KP_{X}, KV_{X}, KF_{X}) as data SPD to the stage controller 19 in order to set the amplification factors KP_{X}, KV_{X}, KF_{X} of the control system WCS_{X}.

Subsequently, the optimizing unit 31 determines a start-X-position X_{S} and a target-X-position X_{E} corresponding thereto of the target track TWP_{X}(t) for evaluating the capability, based on the current position information of the wafer stage WST measured by the wafer laser interferometer 18, and supplies them to the track-calculation unit 36. And the track-calculation unit 36 calculates the target track TWP_{X}(t) based on the start-X-position X_{S} and the target-X-position X_{E} in the same way as in the above target-track calculation, and supplies the calculated, target track TWP_{X}(t) as data STD to the stage controller 19 (more particularly the target-track generation unit 41).

Next, the target-track generation unit 41 of the stage controller 19 generates the target track signal TWP_{X}(t) based on the data STD and supplies it to the control system WCS_{X}, and the control system WCS_{X} controls the position of the wafer stage WST based on the target track signal TWP_{X}(t) supplied.

Next, the optimizing unit 31 monitors the position information of the wafer stage WST supplied by the wafer laser interferometer 18 in order to obtain the positioning error |ΔS| relative to the target-X-position X_{E} when the control system WCS_{X} has finished controlling the position of the wafer stage WST and the time T for converging on a control-completion position, and calculates a value of the evaluation function F using the equation (1).

After the calculation of a value of the evaluation function F for each gene, in a step 115 the optimizing unit 31 names the new group of genes the first generation (t←t+1).

Next, a step 116 checks whether or not alternations of generations have occur up to the t_{M}″th generation. At this time because the answer is NO, the sequence proceeds to a subroutine 118.

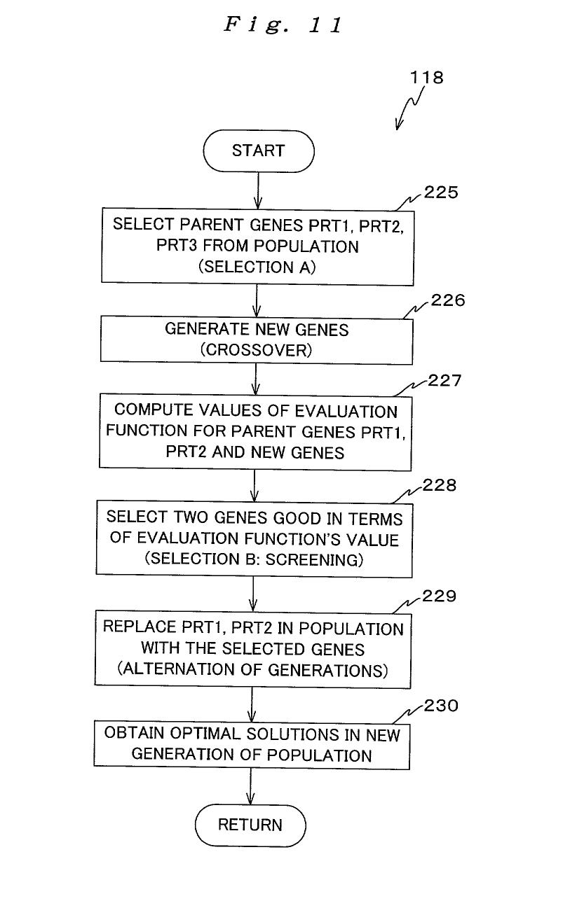

In the subroutine 118, first, steps 225, 226 corresponding to the steps 205, 206 in FIG. 8 are executed as shown in FIG. 11 so that the parent genes PRT1, PRT2 and child genes C1 to C10, which are members of the family (refer to FIG. 9), can be obtained by the selection A and crossover of the genetic algorithm.

Then in a step 227, a value of the evaluation function F is calculated for each of the child genes C1 to C10 of the family in the same way as in the calculation of the evaluation function F for each gene in the step 114.

Next, steps 228, 229 in FIG. 11 corresponding to the steps 208, 209 in FIG. 8 are executed so that a new generation of genes is obtained by the selection B (screening) and alternation of generations (refer to FIG. 9) of the genetic algorithm.

In a step 230 the best gene having the smallest value of the evaluation function F in the new generation of genes is obtained; the process of the subroutine 118 ends, and the sequence returns to a step 115 of the main routine in FIG. 5.

Subsequently, in the step 115 the new group of genes becomes the second generation (t←t+1). Next, a step 116 checks whether or not alternations of generations have occur up to the t_{M}″th generation.

After that, the steps 205 through 210 of the alternation of generations is repeated until the completion of alternations of generations up to the t_{M}″th generation, and if the answer in the step 116 is YES, the computation by the genetic algorithm ends. Note that if solutions having a smaller value of the evaluation function F than the best solutions have are needed, the genetic algorithm is performed using the t_{M}″th generation of genes as the initial group.

By obtaining the optimum solutions for the t_{M}″th generation in this manner, the optimum solutions of the parameters (KP_{X}, KV_{X}, KF_{X}) for the actual control system WCS_{X} is obtained.

Then, in a step 119 the optimizing unit 31 supplies the optimum solutions of the variables (KP_{X}, KV_{X}, KF_{X}) to the optimum-value setting unit 32, and the optimum-value setting unit 32 supplies the optimum values of the variables (KP_{X}, KV_{X}, KF_{X}) as data SPD to the stage controller 19 in order to set the amplification factors KP_{X}, KV_{X}, KF_{X} of the control system WCS_{X} to the optimum values.

Although setting of the parameters (KP_{X}, KV_{X}, KF_{X}) in the actual control system WCS_{X} was described above, the parameters (KP_{X}, KV_{X}, KF_{X}) are set to optimum values in the control system RCS and the control system WCS_{Y} likewise.

After the optimization of the control systems RCS, WCS_{X}, WCS_{Y} described above, the exposure apparatus 100 of this embodiment performs exposure in the following manner.

First, a reticle loader (not shown) loads a reticle R on which a pattern to be transferred is formed onto the reticle stage RST while the control system RCS optimized in the above way is controlling the movement of the reticle stage RST to a loading position.

Almost simultaneously with the loading of the reticle R, a wafer loader (not shown) loads a wafer W to be exposed onto the wafer stage WST while the control systems WCS_{X}, WCS_{Y} optimized in the above way are controlling the movement of the wafer stage WST to a loading position.

Next, the main controller 20 performs preparation such as reticle-alignment and base-line measurement, using a reticle microscope (not shown), the reference mark plate (not shown) on the wafer stage WST, and an alignment detection system (not shown) in a predetermined procedure, and then performs alignment measurement such as EGA (Enhanced Global Alignment) using the alignment detection system. During those operations the movement of the reticle stage RST and the wafer stage WST, if necessary, are controlled by the control systems RCS, WCS_{X}, WCS_{Y} optimized. After the completion of the alignment measurement, exposure of a step-and-scan method is performed in the following manner.

In the exposure operation, first, the wafer stage WST is moved by the control systems WCS_{X}, WCS_{Y} optimized so that a first shot of the wafer W can be positioned in a scan start position for exposure. Likewise, the reticle stage RST is moved by the optimized control system RCS so that the reticle R can be positioned in a scan start position for reticles.

The reticle stage RST and the wafer stage WST are moved synchronously by the optimized control system RCS and the optimized control systems WCS_{X}, WCS_{Y} respectively so that the reticle R and the wafer W move synchronously during the scan exposure.

After the completion of transferring the reticle pattern onto the first shot area by the scan exposure described above, the wafer stage WST is moved by the optimized control systems WCS_{X}, WCS_{Y} so that a next shot of the wafer W can be positioned in the scan start position for exposure. At the same time, the reticle stage RST is moved by the optimized control system RCS so that the reticle R can be positioned in the scan start position for reticles. Then the scan exposure is performed on the next shot in the same way as on the first shot area.

The sequence of moving the wafer stage WST to position a next shot area in the scan start position and moving the reticle stage RST to position the reticle R in the scan start position for reticles and then performing the scan exposure is repeated until the transfer of the pattern is completed for a given number of shots on the wafer.

That is, in this embodiment, during the exposure operations the reticle stage RST and the wafer stage WST are controlled and positioned by the control systems RCS, WCS_{X}, WCS_{Y} optimized.

In the exposure apparatus 100 of this embodiment because the values of the variable parameters of the control systems RCS, WCS_{X}, WCS_{Y} are adjusted and optimized in the capability of positioning accuracy and positioning time, using the global search, the reticle stage RST and the wafer stage WST can be accurately and swiftly positioned, the control systems RCS, WCS_{X}, WCS_{Y} controlling the positions of the reticle stage RST and the wafer stage WST. Therefore, the pattern on the reticle R can be accurately and swiftly transferred onto the wafer W.

Moreover, in optimizing the variable parameters of the control systems RCS, WCS_{X}, WCS_{Y}, because the genetic algorithm is used which is suitable for the global optimization, the optimum values of the variable parameters can be obtained easily and swiftly.

Furthermore, before optimizing the variable parameters of the actual control systems RCS, WCS_{X}, WCS_{Y}, the optimum values of the variable parameters on design are obtained using the control model, and the range where actual, optimum values of the variable parameters are supposed to exist is obtained taking account of the difference between the control model and the actual control system. Then optimum values of the variable parameters are searched for within the range. Therefore, times of trying the positioning by the actual system can be reduced, and the final optimum values can be swiftly obtained without decreasing the accuracy of the final optimum values.

<<A Second Embodiment>>

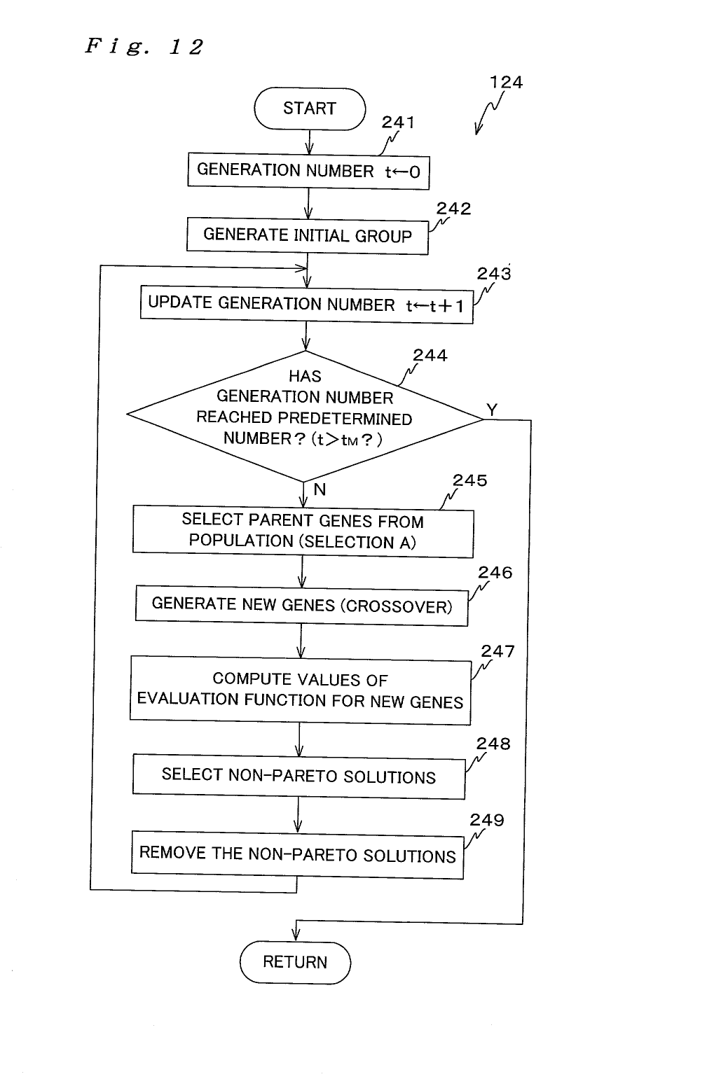

Next, A second embodiment of the present invention will be described below with reference to FIGS. 12 to 15. An exposure apparatus of this embodiment has the same structure as the exposure apparatus 100 of the first embodiment. Because a different genetic algorithm is used for optimizing the variable parameters of the control systems RCS, WCS_{X}, WCS_{Y}, a different evaluation function is employed, and the processes of the subroutines 124 and 118 are different from those of the first embodiment. The second embodiment will be described focusing on those differences. It is noted that elements that are the same as or equivalent to those of the first embodiment are indicated by the same symbols and the same explanation will be omitted.

In this embodiment, the evaluation function F with respect to the capability of positioning and an evaluation function G given by the sum of the variable parameters of the control system RCS, WCS_{X} or WCS_{Y} are employed in order to evaluate the capabilities of the control systems RCS, WCS_{X}, WCS_{Y}. For example, the evaluation function G for the control system WCS_{X} is given by the equation

G=KP_{X} +KV_{X} +KF_{X} (4)

Here, although the evaluation functions F, G vary almost independently of each other as the values of the variable parameters vary, there is a tendency that as the value of the evaluation function F decreases, the value of the evaluation function G increases and as the value of the evaluation function F increases, the value of the evaluation function G decreases.

In this embodiment, multi-objective optimization which minimizes both the evaluation functions F, G is performed by obtaining Pareto-optimal solutions using a genetic algorithm and non-Pareto optimal selection strategy. Here, a Pareto solution means a solution that is excellent in at least one evaluation criterion compared with other solutions whose values are substantially the same in the other evaluation function. That is, a Pareto solution in this embodiment means a gene for which the value of at least one of the evaluation functions F, G is smaller than those for the other genes. Incidentally, the non-Pareto optimal selection strategy is disclosed in “Kobayashi, S., Yoshida, K. and Yamamura, M.: Generating a Set of Pareto Optimal Decision Trees by Genetic Algorithms, Journal of Japanese Society for Artificial Intelligence, Vol. 11, No. 5, pp. 778-785 (1996)”.

Next, how the control parameters of the control systems RCS, WCS_{X}, WCS_{Y} for positioning the reticle stage RST and the wafer stage WST are adjusted and optimized will be described taking the control system WCS_{X} as an example. In such adjustment, the values of the amplification factors KP_{X}, KV_{X}, KF_{X} are optimized which can be set, as described in the first embodiment.

First, a pre-process with respect to the amplification factors KP_{X}, KV_{X}, KF_{X} is performed in a subroutine 111 of FIG. 5, the pre-process being for obtaining the range where the optimum values of the amplification factors KP_{X}, KV_{X}, KF_{X} are present.

As shown in FIG. 6, in the subroutine 111, first, a control system model corresponding to the control system WCS_{X} in FIG. 4 is created as described in the first embodiment. Next, in a step 122 the evaluation functions F, G are designated as evaluation functions for evaluating the capability of the control system WCS_{X}. Then in a step 123 the target track TWP_{X}(t) is obtained as in the first embodiment, which is to be employed in evaluating the capability of positioning using the control system model.

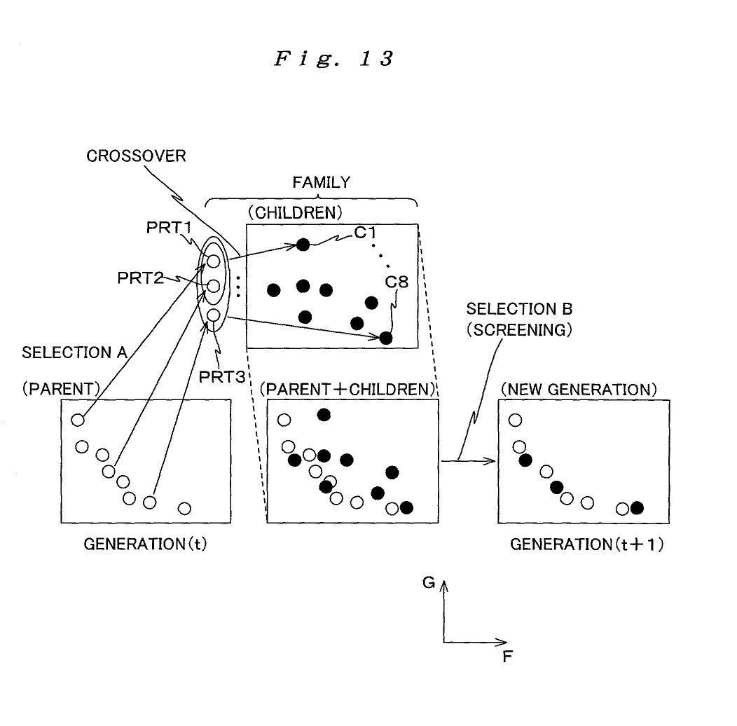

Next, in a subroutine 124 the target track TWP_{X}(t) obtained is inputted into the control system model created in the step 121 in order to obtain the values of the amplification factors KP_{X}, KV_{X}, KF_{X} that minimize the evaluation functions F, G, i.e. optimum solutions. Note that the subroutine 124 searches for Pareto-optimal solutions using the genetic algorithm and the non-Pareto optimal selection strategy in order to obtain optimum solutions from the results of the search. In the below how to search for Pareto-optimal solutions of the variables (KP_{X}, KV_{X}, KF_{X}) in the subroutine 124 will be described with reference to a flow chart of FIG. 12 and FIG. 13, as needed, which illustrates the process of transition from an initial group of genes to another group of genes including the Pareto-optimal solutions. Also in this embodiment, the initial group is the first generation, and alternations of generations occur up to the t_{M}′th generation (e.g. t_{M}=100,000).

First, in a step 241 of FIG. 12 the ‘t’ is set to zero (the 0′th generation). Then in a step 242 the initial group of genes is generated which consists of a plurality of genes each of which contains random values of variables (KP_{X}, KV_{X}, KF_{X}). Also in this embodiment the initial group is composed of 40 genes. For each gene of the initial group, as in the calculation of the evaluation function F described in the first embodiment, the operation simulation of the control-system model is performed using the target track TWP_{X}(t), and based on the result of the simulation, the value of the evaluation function F is calculated while the value of the evaluation function G is calculated based on values of the variables (KP_{X}, KV_{X}, KF_{X}) of each gene using the equation (4). The values of the evaluation functions F, G of each gene represent a coordinate position in a F-G coordinate system, which is indicated by an empty circle in FIG. 13 (parents; at the left bottom of the figure). And in a step 243 the initial group is named the first generation (t←t+1).

Next, a step 244 checks whether or not alternations of generations have occur up to the t_{M}′th generation. At this point of time, because the answer is NO, the sequence proceeds to a step 245. In the step 245, three parent genes PRT1, PRT2, PRT3 are randomly selected from the group of genes (population), as indicated by selection A in FIG. 13, and in a step 246, for example, eight child genes C1 to C8 are generated from the parent genes PRT1, PRT2, PRT3 by crossover as described in the first embodiment.

Then in a step 247, for each of the child genes C1 to C8, the operation simulation of the control-system model is performed using the target track TWP_{X}(t), and based on the result of the simulation, the value of the evaluation function F is calculated while the value of the evaluation function G is calculated based on values of the variables (KP_{X}, KV_{X}, KF_{X}) of each of the child genes C1 to C8 using the equation (4). The values of the evaluation functions F, G of each child gene represent a coordinate position in the F-G coordinate system, which is indicated by a filled circle in FIG. 13 (parents; at the top of the figure).

Next, in a step 248 non-Pareto solutions are selected from a group of the t′th generation of genes and the child genes C1 to C8 ((parent+children) in FIG. 13; at the center bottom of the figure). That is, of the (parent+children) group of genes, others than ones of which the values of the evaluation function G are the smallest among ones having almost the same value of the evaluation function F are selected, and others than ones of which the values of the evaluation function F are the smallest among ones having almost the same value of the evaluation function G are selected. Subsequently, in a step 249 Pareto solutions are selected by excluding the non-Pareto solutions (selection B in FIG. 13). In this way a new generation of genes, which are Pareto solutions at this time has been obtained. The values of the evaluation functions F, G of the genes of the new generation (the (t+1)′th generation) are shown as coordinate positions in the F-G coordinate system in FIG. 13 (new generation; at the right bottom of the figure).

After this alternation of generations the sequence proceeds to the step 243, and the new group is named the second generation (t←t+1). Next, the step 244 checks whether or not alternations of generations have occur up to the t_{M}′th generation.

After that, the alternation of generations in the steps 245 through 249 is repeated until the completion of alternations of generations up to the t_{M}′th generation, and when the answer in the step 244 is YES, the computation by the genetic algorithm ends.

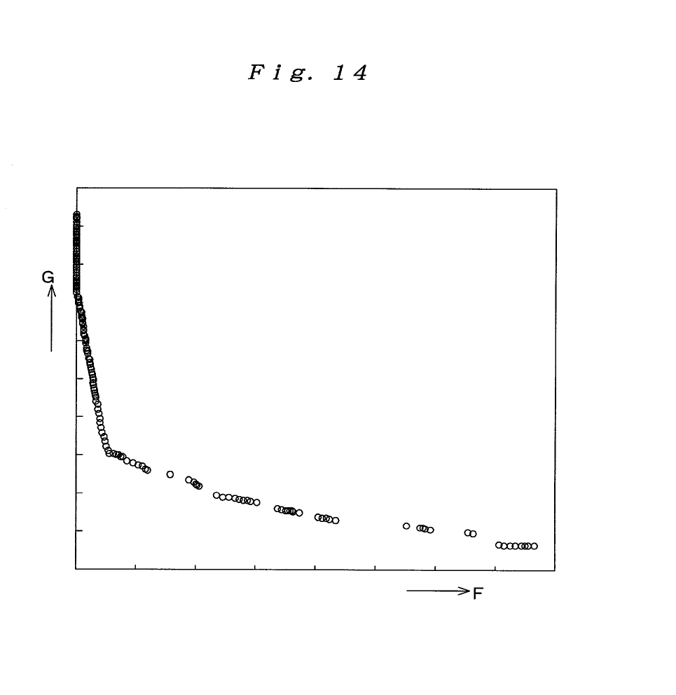

Pareto solutions for the t_{M}′th generation are obtained in this way to obtain a group of Pareto optimal solutions of the variables (KP_{X}, KV_{X}, KF_{X}). The values of the evaluation functions F, G of Pareto optimal solutions are shown as coordinate positions in the F-G coordinate system in FIG. 14. The group of Pareto optimal solutions is displayed on the display unit 21 to present information as to the Pareto optimal solutions to the designer or operator.

The designer or operator, based on the information as to the Pareto optimal solutions, determines a trade-off ratio of the evaluation functions F, G, and inputs the trade-off ratio into the main controller 20 (more particularly the optimizing unit 31) operating the input unit 22. Subsequently, the optimizing unit 31 determines Pareto optimal solutions which meet the given trade-off ratio, and the values of the variables (KP_{X}, KV_{X}, KF_{X}) of the Pareto optimal solutions represent the optimum values for the control system model.

Then for each of various kinds of modeling errors between the actual control system WCS_{X} and the control-system model, the range where optimum values of the parameters (KP_{X}, KV_{X}, KF_{X}) for the actual control system WCS_{X} are supposed to exist and which includes optimum solutions for the control-system model of the control system WCS_{X} is determined. When the pre-process on the variable parameters of the control system WCS_{X} ends in this way, the process of the subroutine 111 ends, and the sequence returns to the main routine (step 112) in FIG. 5.

Next, in the step 112 of FIG. 5, according to instructions of the controller 39 the optimizing unit 31 sets the evaluation functions F, G as functions for evaluating the capability of the control system WCS_{X}. This is because the purpose of adjustment for optimizing is to improve the capability of controlling the position of the wafer stage WST, which is evaluated using the evaluation function F, as in the above control-system model.

It is noted that in the adjustment for optimizing the variable parameters of the control system WCS_{X} in this embodiment, the non-Pareto optimal selection strategy of the genetic algorithm as in the above control-system model is used to search for optimum values of the variable parameters. Moreover, in the search of the optimum values of the variable parameters of the control system WCS_{X} by the genetic algorithm, an initial group is the first generation, and alternations of generations occur up to the t_{M}″th generation (e.g. t_{M}′=several tens to several hundred) for the same reason as in the first embodiment.

Next, in the step 113 the optimizing unit 31 sets the ‘t’ to zero (the 0′th generation), and, in the step 114, generates the initial group which consists of a plurality of genes each of which contains random values of the variables (KP_{X}, KV_{X}, KF_{X}), which values are within the respective ranges obtained in the subroutine 111. For each of genes of the initial group the value of the evaluation function F is calculated as described in the first embodiment while the value of the evaluation function G of each gene is calculated using the equation (4).

After the obtaining of the values of the evaluation functions F, G for each gene, in the step 115 the optimizing unit 31 names the initial group the first generation (t←t+1).

Next, the step 116 checks whether or not alternations of generations have occur up to the t_{M}″th generation. At this point of time, because the answer is NO, the sequence proceeds to the subroutine 118.

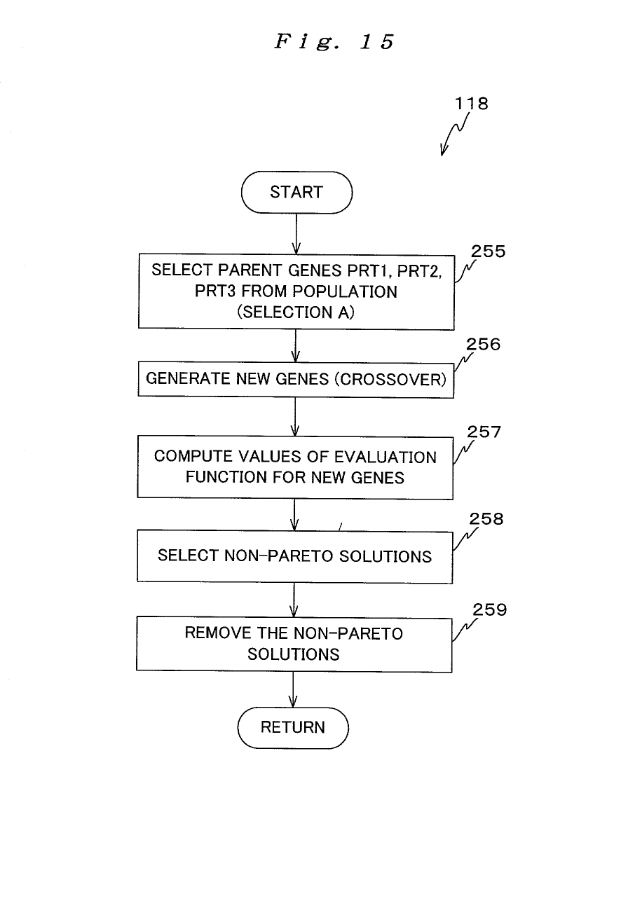

In the subroutine 118, as shown in FIG. 15, steps 255, 256 corresponding to the steps 245, 246 in FIG. 12 are executed to obtain the parent genes PRT1, PRT2 and eight child genes C1 to C8, which are members of the family in FIG. 13, by selection A and crossover of the above genetic algorithm.

Then in a step 257, for each of the child genes C1 to C8 of the family, the value of the evaluation function F is calculated in the same way as described in the above step 114 while the value of the evaluation function G is calculated using the equation (4).

Then steps 258, 259 in FIG. 15 corresponding to the steps 248, 249 in FIG. 12 are executed to obtain a new generation of genes by selection B and alternation of generations (refer to FIG. 13) of the above genetic algorithm. And the process of the subroutine 118 ends, and the sequence proceeds to the step 115 of the main routine in FIG. 5.

Subsequently, in the step 115 the new group of genes is named the second generation (t←t+1). Next, the step 116 checks whether or not alternations of generations have occur up to the t_{M}″th generation.

After that, the alternation of generations in the steps 115 through 118 is repeated until the completion of alternations of generations up to the t_{M}″th generation, and when the answer in the step 116 is YES, the computation by the genetic algorithm ends.

A group of Pareto solutions for the t_{M}″th generation are obtained in this way to obtain and display a group of Pareto optimal solutions of the variables (KP_{X}, KV_{X}, KF_{X}) in the actual control system WCS_{X} on the display unit 21. By this, information as to the Pareto optimal solutions is provided to the designer or operator.

The designer or operator, based on the information as to the Pareto optimal solutions, determines a trade-off ratio of the evaluation functions F, G, and inputs the trade-off ratio into the main controller 20 (more particularly the optimizing unit 31) operating the input unit 22. Subsequently, the optimizing unit 31 determines Pareto optimal solutions which meet the given trade-off ratio, and the values of the variables (KP_{X}, KV_{X}, KF_{X}) of the Pareto optimal solutions represent the optimum values for the control system WCS_{X}.

Then, in the step 119 the optimizing unit 31 supplies the optimum solutions of the variables (KP_{X}, KV_{X}, KF_{X}) for the control system WCS_{X} to the optimum-value setting unit 32, and the optimum-value setting unit 32 supplies the optimum values of the variables (KP_{X}, KV_{X}, KF_{X}) as data SPD to the stage controller 19 in order to set the amplification factors KP_{X}, KV_{X}, KF_{X} of the control system WCS_{X} to the optimum values.

Although the multi-objective optimization of the parameters (KP_{X}, KV_{X}, KF_{X}) in the control system WCS_{X} was described above, the three parameters (KP_{X}, KV_{X}, KF_{X}) are set to optimum values in the control system RCS and the control system WCS_{Y} likewise.

After the multi-objective optimization of the control systems RCS, WCS_{X}, WCS_{Y} described above, the exposure apparatus 100 of this embodiment performs exposure in the same way as in the first embodiment. That is, in this embodiment, during the exposure operations the reticle stage RST and the wafer stage WST are controlled and positioned by the control systems RCS, WCS_{X}, WCS_{Y} optimized in the multi-objective manner.

In the exposure apparatus 100 of this embodiment because the values of the variable parameters of the control systems RCS, WCS_{X}, WCS_{Y} are adjusted and optimized in the capability of positioning accuracy and positioning time, using the global search, the reticle stage RST and the wafer stage WST can be accurately and swiftly positioned, the control systems RCS, WCS_{X}, WCS_{Y} controlling the positions of the reticle stage RST and the wafer stage WST. Therefore, the pattern on the reticle R can be accurately and swiftly transferred onto the wafer W.

Moreover, in optimizing the variable parameters of the control systems RCS, WCS_{X}, WCS_{Y}, because the genetic algorithm is used which is suitable for the global optimization, the optimum values of the variable parameters can be obtained easily and swiftly.

Furthermore, before the multi-objective optimization of the variable parameters of the actual control systems RCS, WCS_{X}, WCS_{Y}, the optimum values of the variable parameters on design are obtained using the control model, and the range where actual, optimum values of the variable parameters are supposed to exist is obtained taking account of the difference between the control model and the actual control system. Then optimum values of the variable parameters are searched for within the range. Therefore, times of trying the positioning by the actual system can be reduced, and the final optimum values can be swiftly obtained without decreasing the accuracy of the final optimum values.

Note that although, in the first and second embodiments, the calculation of the optimum values of the parameters for the control system model is executed just before the optimizing and adjusting of the parameters, it may be executed when designing the control systems RCS, WCS_{X}, WCS_{Y}. And the optimized control systems RCS, WCS_{X}, WCS_{Y} can be provided in the exposure apparatus.

Furthermore, the evaluation function for evaluating the capability may be another function other than the above evaluation functions F and G, for example, given by the function

F′=|ΔX|×T (3).

Also in this case by minimizing the value of the evaluation functions F′ the accuracy and swiftness of positioning can be improved overall. Moreover, the evaluation function may be one for evaluating other capability than the accuracy and swiftness of positioning. Needless to say, the same modifications go for the evaluation function G.

It is noted that this invention can be applied to step-and-repeat exposure-apparatuses, step-and-scan exposure-apparatuses and step-and-stitching exposure-apparatuses and also to the stage control systems of exposure-apparatuses such as wafer exposure apparatuses and liquid crystal exposure apparatuses, and even also to the stage control systems of inspection apparatuses different from exposure apparatuses.

Moreover, this invention can be applied to designing and adjusting a control system other than stage control systems, where the evaluation function, for given capability, having a single bottom (unimodal) when the values of parameters change is not guaranteed, so as to optimize it and also to designing and adjusting a control system other than stage control systems so as to optimize a plurality of capabilities (multi-objective optimization).

Although the embodiments according to the present invention are preferred embodiments, those skilled in the art of lithography systems can readily think of numerous additions, modifications and substitutions to the above embodiments, without departing from the scope and spirit of this invention. It is contemplated that any such additions, modifications and substitutions will fall within the scope of the present invention, which is defined by the claims appended hereto.

What is claimed is:

1. A design method with which to design a control system that controls an object to be controlled, the design method comprising:
providing a control system model having a continuously variable parameter for the control system;
providing at least one evaluation function that evaluates capability of the control system and where a unimodal is not guaranteed when the continuously variable parameter varies; and
obtaining a value of the continuously variable parameter at which the evaluation function takes on an optimal value.

2. The design method with which to design a control system according to claim 1, wherein in the obtaining of a value of the continuously variable parameter, an optimal solution of the continuously variable parameter is obtained by using a genetic algorithm.

3. The design method with which to design a control system according to claim 1, wherein the object to be controlled is a stage on which a body is mounted, and the control system is a stage control system that drives and controls the stage.

4. A design method with which to design a control system that controls an object to be controlled, the design method comprising:
providing a control system model having a continuously variable parameter for the control system;
providing a plurality of evaluation functions that evaluate capability of the control system and that vary independently of each other when the continuously variable parameter varies; and
obtaining a value of the continuously variable parameter at which the plurality of evaluation functions take on respective optimal values simultaneously.

5. The design method with which to design a control system according to claim 4, wherein in at least one of the plurality of evaluation functions a unimodal is not guaranteed when the continuously variable parameter varies.

6. The design method with which to design a control system according to claim 4, wherein in the obtaining of a value of the continuously variable parameter, an optimal solution of the continuously variable parameter is obtained by using a genetic algorithm.

7. The design method with which to design a control system according to claim 6, wherein the control system model has a plurality of continuously variable parameters, and in obtaining values of the plurality of continuously variable parameters, a plurality of Pareto optimal solutions of a group of the plurality of continuously variable parameters are obtained simultaneously.

8. The design method with which to design a control system according to claim 4, wherein the object to be controlled is a stage on which a body is mounted, and the control system is a stage control system that drives and controls the stage.

9. A control system designed by using the design method according to claim 1.

10. A control system designed by using the design method according to claim 4.

11. An adjustment method with which to adjust a control system that controls an object to be controlled and that has a continuously variable parameter, the adjustment method comprising:
providing at least one evaluation function that evaluates capability of the control system and where a unimodal is not guaranteed when the continuously variable parameter varies;
obtaining a value of the continuously variable parameter at which the evaluation function takes on an optimal value; and
setting the continuously variable parameter to the value obtained.

12. The adjustment method with which to adjust a control system according to claim 11, wherein in the obtaining of a value of the continuously variable parameter, an optimal solution of the continuously variable parameter is obtained by using a genetic algorithm.

13. The adjustment method with which to adjust a control system according to claim 11, wherein the object to be controlled is a stage on which a body is mounted, and the control system is a stage control system that drives and controls the stage.

14. An adjustment method with which to adjust a control system that controls an object to be controlled and that has a continuously variable parameter, the adjustment method comprising:
obtaining an optimal value on design of the continuously variable parameter, using the design method according to claim 1;
obtaining a value of the continuously variable parameter, within a given range including the optimal value on design of the continuously variable parameter, at which the evaluation function takes on an optimal value in controlling an object to be controlled via the control system; and
setting the continuously variable parameter to the value obtained in the obtaining of a value of the continuously variable parameter.

15. The adjustment method with which to adjust a control system according to claim 14, wherein in the obtaining of a value of the continuously variable parameter, an optimal solution of the continuously variable parameter of the control system is obtained by using a genetic algorithm.

16. The adjustment method with which to adjust a control system according to claim 14, wherein the object to be controlled is a stage on which a body is mounted, and the control system is a stage control system that drives and controls the stage.

17. An adjustment method with which to adjust a control system that controls an object to be controlled and that has a continuously variable parameter, the adjustment method comprising:
providing a plurality of evaluation functions that evaluate capability of the control system and that vary independently of each other when the continuously variable parameter varies;
obtaining a value of the continuously variable parameter at which the plurality of evaluation functions take on respective optimal values simultaneously; and
setting the continuously variable parameter to the value obtained.

18. The adjustment method with which to adjust a control system according to claim 17, wherein in at least one of the plurality of evaluation functions a unimodal is not guaranteed when the continuously variable parameter varies.

19. The adjustment method with which to adjust a control system according to claim 17, wherein in the obtaining of a value of the continuously variable parameter, an optimal solution of the continuously variable parameter is obtained by using a genetic algorithm.

20. The adjustment method with which to adjust a control system according to claim 19, wherein the control system has a plurality of continuously variable parameters, and in the obtaining of values of the plurality of continuously variable parameters, a plurality of Pareto optimal solutions of a group of the plurality of continuously variable parameters are obtained simultaneously.

21. The adjustment method with which to adjust a control system according to claim 17, wherein the object to be controlled is a stage on which a body is mounted, and the control system is a stage control system that drives and controls the stage.

22. An adjustment method with which to adjust a control system that controls an object to be controlled and that has a continuously variable parameter, the adjustment method comprising:
obtaining an optimal value on design of the continuously variable parameter, using the design method according to claim 4;
obtaining a value of the continuously variable parameter, within a given range including the optimal value on design of the continuously variable parameter, at which the plurality of evaluation functions simultaneously take on respective optimal values in controlling an object to be controlled via the control system; and
setting the continuously variable parameter to the value obtained in the obtaining of a value of the continuously variable parameter.

23. The adjustment method with which to adjust a control system according to claim 22, wherein in the obtaining of a value of the continuously variable parameter, an optimal solution of the continuously variable parameter is obtained by using a genetic algorithm.

24. The adjustment method with which to adjust a control system according to claim 23, wherein the control system has a plurality of continuously variable parameters, and in the obtaining of values of the plurality of continuously variable parameters, a plurality of Pareto optimal solutions of a group of the plurality of continuously variable parameters are obtained simultaneously.

25. The adjustment method with which to adjust a control system according to claim 22, wherein the object to be controlled is a stage on which a body is mounted, and the control system is a stage control system that drives and controls the stage.

26. An exposure method comprising:
providing the control system according to claim 9 serving as a stage control system that controls movement of a stage on which a body to be positioned in a path of an exposure beam is mounted; and
radiating an exposure beam while controlling the stage via the stage control system.

27. The exposure method according to claim 26, wherein the body is a substrate that is exposed to the exposure beam.

28. An exposure method comprising:
providing the control system according to claim 10 serving as a stage control system that controls movement of a stage on which a body to be positioned in a path of an exposure beam is mounted; and
radiating an exposure beam while controlling the stage via the stage control system.

29. The exposure method according to claim 28, wherein the body is a substrate that is exposed to the exposure beam.

30. An exposure method comprising:
adjusting a stage control system that controls movement of a stage on which a body to be positioned in a path of an exposure beam is mounted, by using the adjustment method according to claim 13; and
radiating an exposure beam while controlling the stage via the stage control system adjusted in the adjusting.

31. The exposure method according to claim 30, wherein the body is a substrate that is exposed to the exposure beam.

32. An exposure method comprising:
adjusting a stage control system that controls movement of a stage on which a body to be positioned in a path of an exposure beam is mounted, by using the adjustment method according to claim 16; and
radiating an exposure beam while controlling the stage via the stage control system adjusted in the adjusting.

33. The exposure method according to claim 32, wherein the body is a substrate that is exposed to the exposure beam.

34. An exposure method comprising:
adjusting a stage control system that controls movement of a stage on which a body to be positioned in a path of an exposure beam is mounted, by using the adjustment method according to claim 21; and
radiating an exposure beam while controlling the stage via the stage control system adjusted in the adjusting.

35. The exposure method according to claim 34, wherein the body is a substrate that is exposed to the exposure beam.

36. An exposure method comprising:
adjusting a stage control system that controls movement of a stage on which a body to be positioned in a path of an exposure beam is mounted, by using the adjustment method according to claim 25; and
radiating an exposure beam while controlling the stage via the stage control system adjusted in the adjusting.

37. The exposure method according to claim 36, wherein the body is a substrate that is exposed to the exposure beam.

38. An exposure apparatus that transfers a predetermined pattern onto a substrate by illuminating the substrate with an exposure beam, the exposure apparatus comprising:
a beam source that generates the exposure beam; and
the control system according to claim 9 that drives and controls a stage on which the substrate is mounted.

39. An exposure apparatus that transfers a predetermined pattern onto a substrate by illuminating the substrate with an exposure beam, the exposure apparatus comprising:
a beam source that generates the exposure beam; and
the control system according to claim 10 that drives and controls a stage on which the substrate is mounted.

40. An exposure apparatus that transfers a predetermined pattern onto a substrate by illuminating the substrate with an exposure beam, the exposure apparatus comprising:
a beam source that generates the exposure beam; and
a stage control system that can be adjusted using the adjustment method according to claim 21, and drives and controls a stage on which the substrate is mounted.
